(19) United States
(12) Patent Application Publication
(10) Pub. No.: US 2017/0177063 A1
(43) Pub. Date: Jun. 22, 2017

(54) Learned User Interface Interactivity Tolerance Based On Information Complexity

(71) Applicant: International Business Machines Corporation, Armonk, NY (US)

(72) Inventor: Adam Harley Eugene Ederbach, Surrey Hills (AU)

(73) Assignee: INTERNATIONAL BUSINESS MACHINES CORPORATION

(21) Appl. No.: 14/972,862

(22) Filed: Dec. 17, 2015

(51) Int. Cl. G06F 1/32; G09G 5/00; G06N 99/00; G06F 3/0481

(52) U.S. Cl. CPC G06F 1/3231; G06F 3/0481; G09G 5/003; G06F 1/3212; G06F 1/3218; G06N 99/005; G09G 2330/022; G09G 2330/023

(57) ABSTRACT

A method apparatus, and computer program product are provided for learned user interface interactivity tolerance based on information complexity. The method may include determining an expected content display time for at least a part of content to be displayed to a user of a user device; displaying the at least part of the content to the user; monitoring a time period of inactivity during which the user device does not detect an input from the user; in response to receiving an indication that the user device is preparing to enter a sleep state, comparing the time period of inactivity with the expected content display time of the at least part of the content; and determining whether to cause the user device to enter the sleep state based at least on the comparison.

### TECHNICAL FIELD

This invention relates generally to user interfaces and, more specifically, relates to learned user interface interactivity tolerance based on information complexity.

### BACKGROUND

This section is intended to provide a background or context to the invention disclosed below. The description herein may include concepts that could be pursued, but are not necessarily ones that have been previously conceived, implemented or described. Therefore, unless otherwise explicitly indicated herein, what is described in this section is not prior art to the description in this application and is not admitted to be prior art by inclusion in this section.

The management of power consumption is an important function of modern operating systems, especially when a system is powered by battery. Operating systems typically seek to minimize power consumption when a period of no user input has been detected by entering a sleep state. Applications may prevent an operating system from entering a sleep state. However, it is important that applications strike a balance between providing a user with a seamless experience when using the application and conserving energy to preserve battery life. Thus, it is important that applications do not prevent the operating system from ever entering a sleep state.

### SUMMARY

According to an embodiment described herein a method is provided, the method comprising determining an expected content display time for at least a part of content to be displayed to a user of a user device; displaying the at least part of the content to the user; monitoring a time period of inactivity during which the user device does not detect an input from the user; in response to receiving an indication that the user device is preparing to enter a sleep state, comparing the time period of inactivity with the expected content display time of the at least part of the content; and determining whether to cause the user device to enter the sleep state based at least on the comparison.

According to another embodiment described herein an apparatus is provided, the apparatus comprising: at least one processor; and at least one non-transitory memory including computer program code, the at least one memory and the computer program code are configured to, with the at least one processor, cause the apparatus to: determine an expected content display time for at least a part of content to be displayed to a user of a user device; display the at least part of the content to the user; monitor a time period of inactivity during which the user device does not detect an input from the user; in response to receiving an indication that the user device is preparing to enter a sleep state, compare the time period of inactivity with the expected content display time of the at least part of the content; and determine whether to cause the user device to enter the sleep state based at least on the comparison.

According to another embodiment described herein a computer program product is provided, the computer program product comprising a computer readable storage medium having program instructions embodied therewith, the program instructions executable by a device to cause the device to: determine an expected content display time for at least a part of content to be displayed to a user of a user device; display the at least part of the content to the user; monitor a time period of inactivity during which the user device does not detect an input from the user; in response to receiving an indication that the user device is preparing to enter a sleep state, compare the time period of inactivity with the expected content display time of the at least part of the content; and determine whether to cause the user device to enter the sleep state based at least on the comparison.

### BRIEF DESCRIPTION OF THE DRAWINGS

These and other features, aspects, and advantages of the present invention will become better understood with regard to the following description, appended claims, and accompanying drawings, where:

FIG. 1 shows a high level schematic block diagram illustrating a computing device that is suitable for practicing the described and exemplary embodiments of these teachings;

FIG. 2 and FIG. 3 are process flow diagrams showing operation of an apparatus according to certain exemplary embodiments of these teachings;

FIG. 4 is a logic flow diagram for learned user interface interactivity tolerance based on information complexity, and illustrates the operation of an exemplary method, a result of execution of computer program instructions embodied on a computer readable memory, functions performed by logic implemented in hardware, and/or interconnected means for performing functions in accordance with exemplary embodiments.

### DETAILED DESCRIPTION

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

The exemplary embodiments herein describe techniques for learned user interface interactivity tolerance based on information complexity. Additional description of these techniques is presented after a system into which the exemplary embodiments may be used is described.

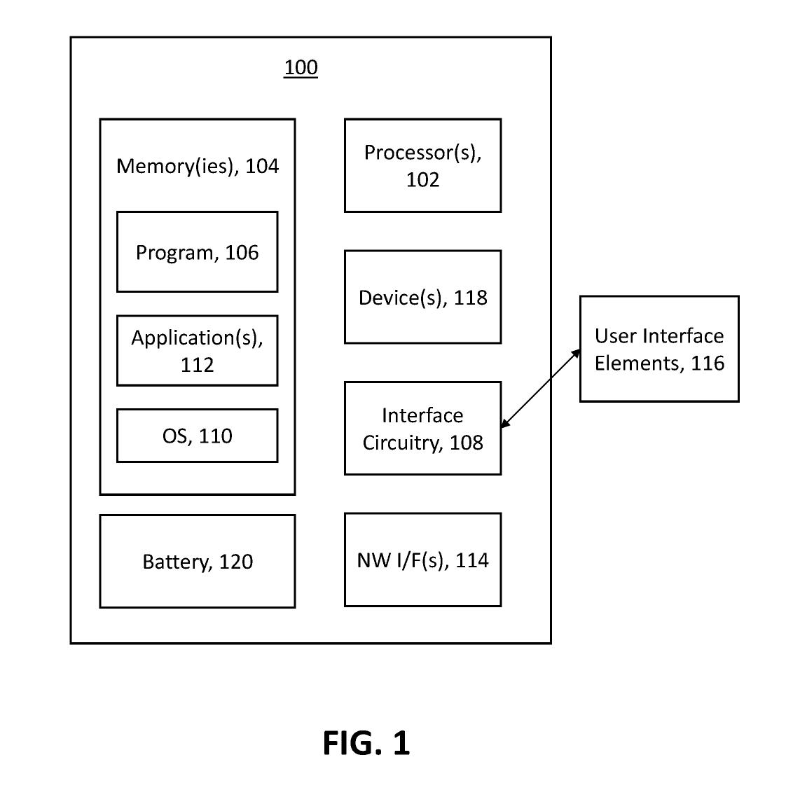

The high level block diagram of FIG. 1, shows a computer system 100. The computer system 100 comprises one or multiple processors 102, one or more multiple memories 104 storing a computer program 106, and interface circuitry 108. The memory(ies) may also store one or more applications 112, and an operating system (OS) 110. Optionally, the computer system 100 may comprise one or more network (N/W) interfaces (I/F(s)) 114. The computer system 100 may include or be connected to one or more user interface elements 116. The one or more memories 104 may comprise functionality as described herein and comprises computer-readable code that, when executed by the one or more processors 102, cause the computer system 100 to perform the functionality described herein.

The computer readable memories 104 may be of any type suitable to the local technical environment and may be implemented using any suitable data storage technology, such as semiconductor based memory devices, flash memory, magnetic memory devices and systems, optical memory devices and systems, fixed memory and removable memory, or some combination of these. The computer readable memories 104 may be means for performing storage functions. The at least one processor 102 may be of any type suitable to the local technical environment, and may include one or more of general purpose processors, special purpose processors, microprocessors, gate arrays, programmable logic devices, digital signal processors (DSPs) and processors based on a multi-core processor architecture, or combinations of these, as non-limiting examples. The at least one processor may be means for performing functions, such as controlling the computer system 100 and other functions as described herein. The network interfaces 114 may be wired and/or wireless and communicate over the Internet/other network via any communication technique. The user interface elements 116 may include, for instance, one or more of keyboards, mice, trackballs, displays (e.g., touch screen or non-touch screen), gesture detector and the like.

The computer system 100 may include a battery 120, for example a rechargeable battery such as a lithium-ion battery, or any other suitable battery to power the computer system 100. The computing system 100 may also include one or more device(s) 118 that can be modified for enabling a sleep mode. For example, screen/screen drivers, RF receivers/transmitters, amplifiers, and the like.

The memory(ies) 104 may store application(s) 112, such as a PDF viewer, games, image viewers, a word processor, and the like. The memory(ies) 104 may store system software, such as the operating system 110 that manages the user device's hardware and software resources and provides common services for computer programs (e.g. program 106 and application(s) 112). The operating system 110 may include various application programmer interfaces (APIs) which may provide certain tools, methods, and protocols for developing applications, e.g. application(s) 112, to be used with the operating system 110. For example, an application developer may utilize an Android™ API to interact with various hardware or software components of an Android device.

In general, the various embodiments of the computer system 100 in FIG. 1 can include, but are not limited to workstations, servers, personal desktop computers, laptop or tablet computers, personal portable digital devices, including but not limited to handheld or wearable computers such as cellular phones, smart phones, and e-book devices.

The term “sleep state” as used herein refers to a state of user device, where the user device has disabled and/or limited the user device's resources to preserve battery life. It should be appreciated that the term sleep state is not intended to be limiting and encompasses other terms such as sleep mode, idle state/mode, power saving state/mode, low power state/mode, and the like.

Users have come to expect a seamless experience when using software on user devices. Software that attempts to make sophisticated decisions to achieve one outcome, e.g. automatic power management, may cause inadvertent side effects. For example, a screen on the user's device may dim or enter sleep state while the user is actively reading or viewing something on the screen, thus breaking the user's concentration. An unhappy user wishing to avoid these sleep state altogether may decide to disable the power management features or limit the power management features (e.g. by manually specifying a longer period of time before the device enters a sleep state). This may cause a severe decrease in overall battery life. Embodiments described herein address these limitations by providing techniques for learning user patterns for specific types of content, and applying those patterns at the appropriate time so as to not interrupt the user. Accordingly, these techniques personalize the user interface and provide better user experience.

According to embodiments described herein, a user device may monitor the user's behavior in relation to content being displayed on the device to gather finely tuned information to determine whether entering a sleep state is likely to inconvenience the user. By learning the user's typical information processing speed and assessing the complexity and quantity of information presented the user device may prevent interruption to the user by adjusting the device power management strategy.

In some embodiments, the operating system is capable of querying applications for recommendations about whether entering a low power state is appropriate. The operating system may receive information from an application indicating either that no impediment to entering a low power state is known to exist, or that based on the user's learned speed of consuming information and the type of information currently displayed, the user is probably still actively considering the information and the operating system should not enter a low power state at this time.

In certain embodiments, an operating system which receives such recommendations from applications capable of responding to these queries, may determine whether the user device should enter a low power state based on other factors, such as current battery state. For example, the operating system may assess the danger of information loss as being worse than the inconvenience of user interruption.

According to some embodiments, an application of a user device may record information based on usage, for example, information about a user's expected time to consume any information presented. An application presenting documents (e.g. a PDF viewer) may record, for each page, the complexity of the information that is to be displayed to the user. As the user advances through the document the application maintains a record of the time spent viewing each page and relates this to the assessed complexity of information.

The complexity of the content may be based on various factors such as: word count, the type of language used, the number of figures and their complexity and other factors. Text which is to be displayed to the user may be analyzed according to readability tests or scores such as the Flesch reading-ease score (FRES) test.

Complexity of pictures or images may be based on the type of images, for example complex maps, diagrams or scans of fine art are likely to be viewed for much longer periods than snapshots of family and friends. Additionally, the complexity may be based on the number, type, resolution or other factors related to the images presented a user.

Web browser software would assess complexity of viewed pages, with complexity of viewed pages being assessed in the same way as for the PDF viewer example, again with viewing time per presentation during which the user does not interact with the device.

A game application may determine complexity based on the type of game. For example, a puzzle game, such as Sudoku, may be viewed for much longer periods of time interaction without input from a user than a racing game which requires constant user input.

By monitoring a user's interaction within the application, the application may estimate the time that the user will spend looking at information of a certain complexity. An operating system having detected user inactivity for a time exceeding the threshold for entering a low power state would normally disrupt the user by seeking to enter the low power state without reference to the estimated time a user may spend consuming the presented information.

A further example of an application capable of making informed decisions about whether sleep mode should be entered is a presentation application, where a user will, when presenting information from the application, interact with the device for brief periods of time and then not interact with the device for longer periods, for example, when talking about the content currently being displayed. The application may detect that it is in full-screen presentation mode, which may indicate that the user will have longer periods of interactivity with the device (e.g. when the user is interacting with the audience). In this situation, the application should prevent the operating system from entering a sleep if at all possible so as to not interrupt the presentation. Another factor on whether the application is being used in this way may be the presence of secondary display devices that are not normally connected. If a secondary display device is detected and a presentation application is in a presentation mode then this would be a very reasonable time for an application to request that a user be allowed a far longer period of inactivity before sleep mode is entered.

The non-limiting examples of the types of content and types of applications provided above are illustrative, and it should be understood that the techniques described herein apply equally to other types of applications and other types of content. For example, a recipe from a cooking application may have only a simple list of text (i.e. ingredients), but the time the user views the text may be longer than normal as the user may be preoccupied with following the recipe (e.g. gathering cooking/measuring utensils, measuring ingredients, cleanings, washings hands, etc.). Accordingly, the complexity of the content may be determined by the number of ingredients, steps, difficulty of recipe, and the like.

In certain embodiments the ability of the user device's operating system to warn the user of an impending low power state enables the correct measuring of time per page. For example, many operating systems dim the screen before entering a low power state which provides the user a period of time to interact with the system which indicates that low power state should not be entered. During this time the user interactivity is intercepted by the operating system without being presented to the application as normal user input. Since the user input is not received by the application, accurate recording of time spent per page is possible even though the operating system may have sought to enter the low power state.

When an operating system detects that a system-wide threshold for inactivity has been exceeded (e.g. an inactivity timer), then the operation typically instructs the device to enter a low power state without reference to running applications. According to certain embodiments described herein before entering a low power or sleep state the operating system first iterates over running applications to check whether the applications conform to a defined protocol for supplying information about the likelihood of entering a low power state interrupting the user. Each application conforming to such a protocol would be polled and any application detecting that information is being presented that is of a complexity likely to require more time for consumption, based on the user's recorded interaction with the application while displaying similar content, may report that to the operating system. If an application detects that content is of a different complexity to content for which user activity has been recorded, then the application may still make intelligent choices, possibly extrapolating or using the most similar content records.

Similar content records may be determined based on the content type (e.g. image, text, etc.), for example, by applying metrics such as FRES or other applicable standards or tests. The content records may be further based on previously gained information about the average amount of time that a user spends viewing a page of content in a given application. An application developer, knowing that their application is usually used to display information of a known complexity, may include information giving a baseline time for information consumption. Alternatively, an application may use the default settings of the operating system and not respond to the protocol requesting information.

According to embodiments described herein, when the operating system receives a response from a running application indicating that the user is likely to be inconvenienced by entering a low power state, the operating system can make an informed decision about entering the low power state. In some embodiments, the operating system usually prevents the device from entering a low power state, unless there is some other overriding reason such as low battery state.

At a suitable time the complexity information may be stored in such a way as to remove information that may identify the content, for example, when closing/exiting the application, closing a document, or the like. For example, the complexity information may be used by the device to generate a score or statistics for the user and be stored using a user profile. The score or statistics may then be used to indicate the time the user would be expected to view or display such information without interactivity. In certain embodiments one or more user profiles may be created for the user device. The one or more user profiles may be specific to certain applications, for example, each application may create and maintain a profile which are used to determine the time the user is expected to view the information without interactivity.

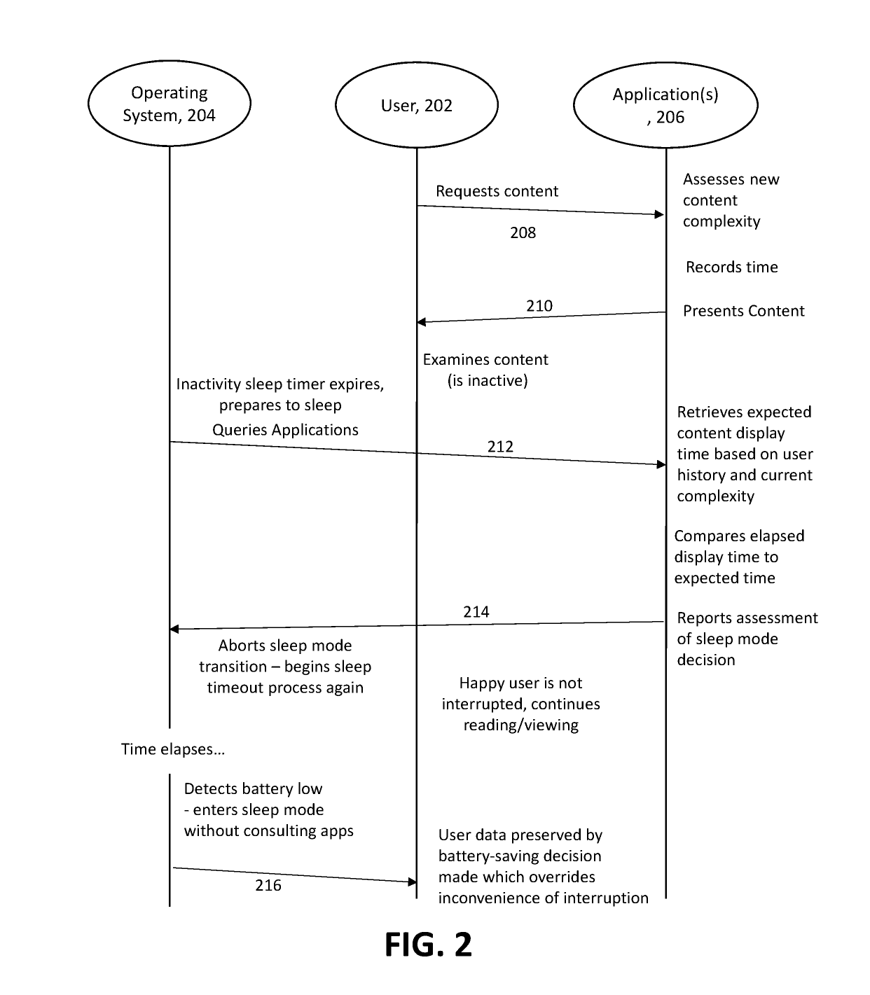

Referring now to FIG. 2, this figure shows a process flow chart according to embodiments described herein. FIG. 2 shows the interaction between a user 202 and a user device comprising an operating system 204 and an application 206. At 208, the user 202 requests certain content from the application. For example, the application 206 may be a PDF reader application and the user 202 may be requesting to display a .pdf document, such as a text book, using the application 206. When the user 202 requests the content, the application assesses a complexity of at least part of the content, displays a part of the content, and begins a timer. At 210, while the part of the content is displayed to the user 202 (e.g. one or more pages from the text book), an elapsed display time is recorded indicating the time the user 202 is not interacting with the device, namely, the user device is not receiving any inputs from the user 202 such as a touch input. If user input is not received, then the operating system 204 may determine that the device should enter a sleep state. For example, the operating system 204 may prepare to enter a sleep state on expiry of an inactivity timer. At 212, the operating system 204 queries the application 206 to determine whether it is appropriate to enter the sleep state. The application 206 retrieves an expected content display time based on user's 202 usage history and current complexity of the content being displayed to the user; and compares the expected content display time to the elapsed display time from the time which started at 210. The application 206 decides whether the sleep should be aborted, for example, if the expected content display time is greater than the elapsed display time the applicant 206 may report that the sleep mode should be aborted. The application 206 reports the assessment of a sleep mode decision to the operating system 204 at 214; and the operating system 204 considers the assessment in determining whether to restart the sleep state inactivity timer, or enter sleep state depending on the assessment. This process can then repeat for other content that the application 206 displays to the user 202 (e.g. other pages from the textbook).

If the operating system 204 follows the applications recommendation to abort the sleep mode at 214, then the operating system 204 may begin its sleep timeout anew. This process may continue for some time with the user 202 being unaware of the actions of the application in preventing the operating system 204 from entering the sleep mode. In some cases, the operating system 204 may detect a low power condition of the user device that may result in data loss. Normally the user 202 is notified of low power conditions through means other than having the operating system 204 enter a sleep mode. However, typically these “low battery” notification can be ignored or dismissed by the user 202. When the operating system 204 detects a low battery state then the operating system 204 may judge that the potential for data loss is greater than the risk of inconveniencing the user 202. In this case, the operating system 204 may enter sleep mode without consulting any application 206 as shown at 216. For this case it matters less whether the user 202 is likely to be genuinely idle or simply not interacting physically with the machine.

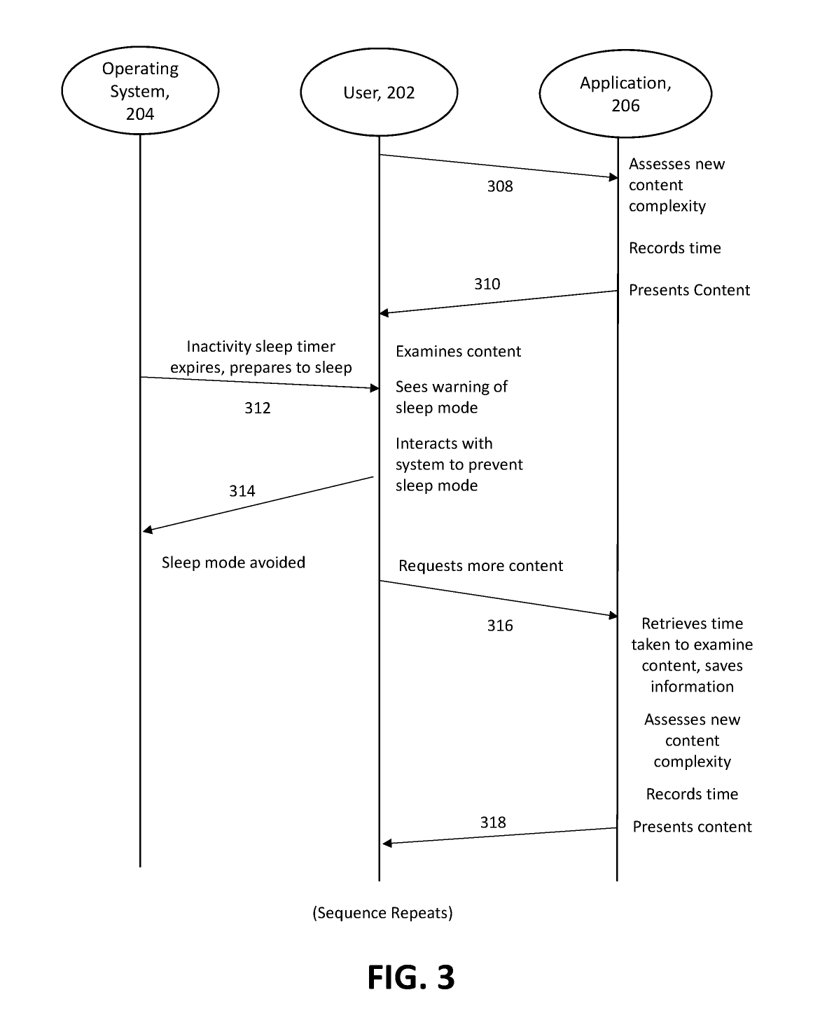

FIG. 3 shows another process flow chart according to embodiments described herein. This figure shows the interaction between a user 202 and a user device comprising an operating system 204 and an application 206. At 308, the user 202 requests certain content from the application 206. When the user 202 requests the content, the application 206 assesses a complexity of at least part of the content, displays a part of the content, and begins an elapsed display timer. At 310, while the part of the content is displayed to the user 202 (e.g. one or more pages from the text book), the elapsed display timer indicates the time the user 202 is not interacting with the device, namely, when the user device is not receiving any input from the user 202 such as a touch input. If the user 202 does not provide input, then the operating system 204 may determine that the device should enter a sleep state based on expiry of an inactivity timer. At 312, the operating system 204 prepares to enter a sleep mode by providing a warning to the user 202, for example by dimming the screen of the user device. At 314, the user 202 interacts with the user device (e.g. by touching a screen, or pressing a button) thus indicating to the operating system 204 that the sleep mode should be avoided. At 316, the user 202 requests an additional part of the content from the application 206. The application 206 then determines the time taken by the user 202 to examiner the content based on the elapsed display timer, and stores this information. The application 206 then assesses the content complexity of the new part of the content requested by the user 202 at 316, which may be based at least partially on previously stored elapsed display timer information. Another elapsed display timer is started and requested additional part of the content is displayed to the user at 318. This process may then be repeated for additional content that the user 202 requests. Thus, the process described in FIG. 3 allows an application 206 to learn user patterns for how long the user 202 is likely to view content of a certain complexity and provide customized recommendations to the operating system 204 on whether to enter a sleep state.

The operating system 204 and the application 206 referenced by FIGS. 2 and 3 may be stored, for example, in the one or more memory(ies) 104 as shown in FIG. 1. Although the above the descriptions above of FIG. 2 and FIG. 3 generally refer to a single application, it should be understood that process also applies to multiple applications that may be running on the device. For example, the operating system 204 could query multiple running applications, each of which may make recommendations on whether the operating system 204 should enter a sleep mode, or record the user 202 history for a given application.

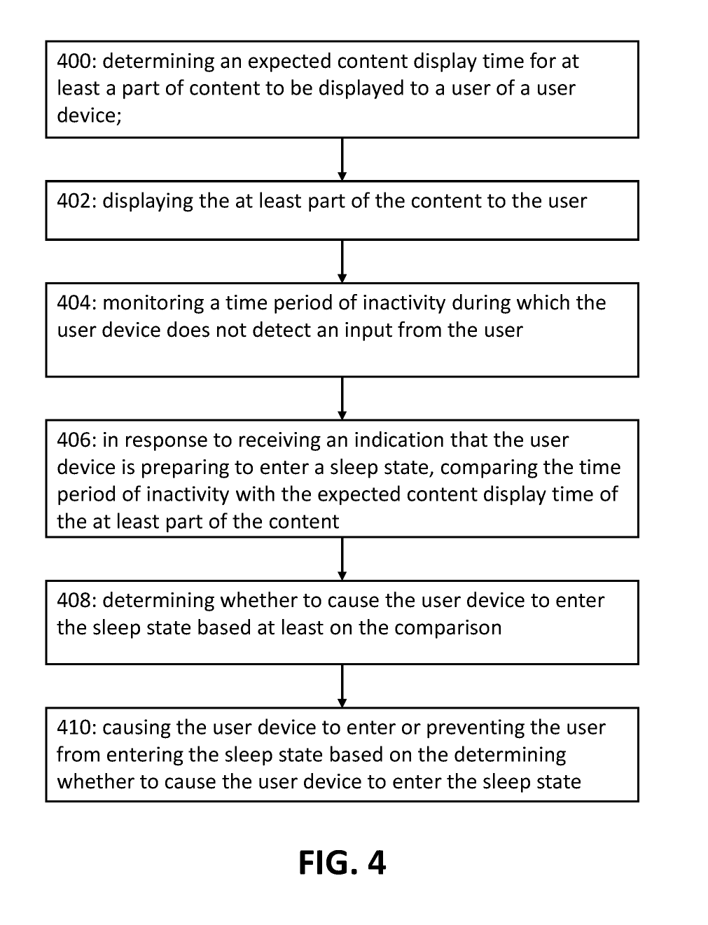

FIG. 4 is a logic flow diagram for learned user interface interactivity tolerance based on information complexity, FIG. 4 illustrates the operation of an exemplary method, a result of execution of computer program instructions embodied on a computer readable memory, functions performed by logic implemented in hardware, and/or interconnected means for performing functions in accordance with exemplary embodiments. It is assumed a user device, such as the computer system 100 of FIG. 1, performs the blocks in FIG. 4.

Referring to FIG. 4, an example method may comprise determining an expected content display time for at least a part of content to be displayed to a user of a user device as indicated by block 400; displaying the at least part of the content to the user as indicated by block 402; monitoring a time period of inactivity during which the user device does not detect an input from the user as indicated by block 404; in response to receiving an indication that the user device is preparing to enter a sleep state, comparing the time period of inactivity with the expected content display time of the at least part of the content as indicated by block 406; and determining whether to cause the user device to enter the sleep state based at least on the comparison as indicated by block 408. The method may comprise causing the user device to enter or preventing the user from entering the sleep state based on the determining whether to cause the user device to enter the sleep state as indicated by block 410.

Determining the expected content display time may be based at least on prior interactive behavior history of the user with other content. The method may comprise displaying a warning to the user in response to the indication that the user device is preparing to enter the sleep state; preventing the user device from entering the sleep state based on subsequent user activity; and in response to an input from the user, determining an expected content display time for at least another part of content to be displayed to the user. The method may comprise detecting an input of the user, prior to receiving the indication that the user device is preparing to enter a sleep state; storing the time period of inactivity in memory of the user device; and using the stored time period of inactivity to update an expected content display time of another part of the content or a part of different content. The at least part of the content may be at least one image and/or text, the determining the expected content display time may comprise estimating a complexity of the at least part of the content, and the expected content display time may be considered to be longer in response to a complexity considered to be high and may considered to be shorter in response to the complexity being considered low. Estimating the complexity of the at least part of the content may be based on at least one of the following: a resolution of the at least one image; the number of the images; a type of the image; a number of words in the text; a language complexity of text; an average word size of the text; and an average sentence size of the text. The indication that the user device is preparing to enter the sleep state may be an expiry of an inactivity timer. For the case the expected content display time of the at least part of the content is greater than the time period of inactivity, the user device may be caused to not enter the sleep state. For the case the expected content display time of the at least part of the content is less than the time period of inactivity, the user device may be caused to enter the sleep state. Determining whether to cause the user device to enter the sleep state may comprise determining a battery status is below a certain threshold, and causing the user device to enter the sleep state regardless of the comparison of the expected content display time of the at least part of the content and the time period of inactivity. An operating system of the user device may determine whether to cause the user device to enter the sleep state.

An example embodiment may be provided in an apparatus, such as shown in FIG. 1 for example. The apparatus may comprise at least one processor; and at least one non-transitory memory including computer program code. The at least one memory and the computer program code may be configured to, with the at least one processor, cause the apparatus to: determine an expected content display time for at least a part of content to be displayed to a user of a user device; display the at least part of the content to the user; monitor a time period of inactivity during which the user device does not detect an input from the user; in response to receiving an indication that the user device is preparing to enter a sleep state, compare the time period of inactivity with the expected content display time of the at least part of the content; and determine whether to cause the user device to enter the sleep state based at least on the comparison.

The determining the expected content display time may be at least on prior interactive behavior history of the user with other content. The at least one memory and the computer program code may be configured to, with the at least one processor, cause the apparatus to: display a warning to the user in response to the indication that the user device is preparing to enter the sleep state; prevent the user device from entering the sleep state based on subsequent user activity; and in response to an input from the user, determine an expected content display time for at least another part of content to be displayed to the user. The at least one memory and the computer program code may be configured to, with the at least one processor, cause the apparatus to: detect an input of the user prior to receiving the indication that the user device is preparing to enter a sleep state; store the time period of inactivity in memory of the user device; and use the stored time period of inactivity to update an expected content display time of another part of the content or a part of different content. The at least part of the content may comprise at least one image and/or text, determining the expected content display time may comprise estimating a complexity of the at least part of the content; and the expected content display time may be considered to be longer in response to a complexity considered to be high and is considered to be shorter in response to the complexity being considered low. The estimating the complexity of the at least part of the content may be based on at least one of the following: a resolution of the at least one image; the number of the images; a type of the image; a number of words in the text; a language complexity of text; an average word size of the text; and an average sentence size of the text. The indication that the user device is preparing to enter the sleep state may be an expiry of an inactivity timer. For the case the expected content display time of the at least part of the content is greater than the time period of inactivity, the user device may be caused to not enter the sleep state; and for the case the expected content display time of the at least part of the content is less than the time period of inactivity, the user device may be caused to enter the sleep state. The determining whether to cause the user device to enter the sleep state may comprise determining a battery status is below a certain threshold, and causing the user device to enter the sleep state regardless of the comparison of the expected content display time of the at least part of the content and the time period of inactivity.

In an example embodiment, a computer program product may be provided comprising a computer readable storage medium having program instructions embodied therewith. The program instructions may be executable by a device to cause the device to: determine an expected content display time for at least a part of content to be displayed to a user of a user device; display the at least part of the content to the user; monitor a time period of inactivity during which the user device does not detect an input from the user; in response to receiving an indication that the user device is preparing to enter a sleep state, compare the time period of inactivity with the expected content display time of the at least part of the content; and determine whether to cause the user device to enter the sleep state based at least on the comparison.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is also noted herein that while the above describes example embodiments of the invention, these descriptions should not be viewed in a limiting sense. Rather, there are several variations and modifications which may be made without departing from the scope of the present invention.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
determining an expected content display time for at least a part of content to be displayed to a user of a user device;
displaying the at least part of the content to the user;
monitoring a time period of inactivity during which the user device does not detect an input from the user;
in response to receiving an indication that the user device is preparing to enter a sleep state, comparing the time period of inactivity with the expected content display time of the at least part of the content; and
determining whether to cause the user device to enter the sleep state based at least on the comparison.

2. The method of claim 1, wherein determining the expected content display time is based at least on prior interactive behavior history of the user with other content.

3. The method of claim 1, further comprising:
displaying a warning to the user in response to the indication that the user device is preparing to enter the sleep state;
preventing the user device from entering the sleep state based on subsequent user activity; and
in response to an input from the user, determining an expected content display time for at least another part of content to be displayed to the user.

4. The method of claim 1, further comprising:
detecting an input of the user prior to receiving the indication that the user device is preparing to enter a sleep state;
storing the time period of inactivity in memory of the user device; and
using the stored time period of inactivity to update an expected content display time of another part of the content or a part of different content.

5. The method of claim 1, wherein the at least part of the content comprises at least one image and/or text, wherein determining the expected content display time comprises estimating a complexity of the at least part of the content, and wherein the expected content display time is considered to be longer in response to a complexity considered to be high and is considered to be shorter in response to the complexity being considered low.

6. The method of claim 5, wherein estimating the complexity of the at least part of the content is based on at least one of the following:
a resolution of the at least one image;
the number of the images;
a type of the image;
a number of words in the text;
a language complexity of text;
an average word size of the text; and
an average sentence size of the text.

7. The method of claim 1, wherein the indication that the user device is preparing to enter the sleep state is an expiry of an inactivity timer.

8. The method of claim 1, wherein:
for the case the expected content display time of the at least part of the content is greater than the time period of inactivity, the user device is caused to not enter the sleep state; and
for the case the expected content display time of the at least part of the content is less than the time period of inactivity, the user device is caused to enter the sleep state.

9. The method of claim 1, wherein determining whether to cause the user device to enter the sleep state comprises:
determining a battery status is below a certain threshold, and causing the user device to enter the sleep state regardless of the comparison of the expected content display time of the at least part of the content and the time period of inactivity.

10. The method of claim 1, wherein an operating system of the user device determines whether to cause the user device to enter the sleep state.

11. An apparatus comprising:
at least one processor; and
at least one non-transitory memory including computer program code,
the at least one memory and the computer program code are configured to, with the at least one processor, cause the apparatus to:
determine an expected content display time for at least a part of content to be displayed to a user of a user device;
display the at least part of the content to the user;
monitor a time period of inactivity during which the user device does not detect an input from the user;
in response to receiving an indication that the user device is preparing to enter a sleep state, compare the time period of inactivity with the expected content display time of the at least part of the content; and
determine whether to cause the user device to enter the sleep state based at least on the comparison.

12. The apparatus of claim 11, wherein determining the expected content display time is based at least on prior interactive behavior history of the user with other content.

13. The apparatus of claim 11, wherein the at least one memory and the computer program code are configured to, with the at least one processor, cause the apparatus to:
display a warning to the user in response to the indication that the user device is preparing to enter the sleep state;
prevent the user device from entering the sleep state based on subsequent user activity; and
in response to an input from the user, determine an expected content display time for at least another part of content to be displayed to the user.

14. The apparatus of claim 11, wherein the at least one memory and the computer program code are configured to, with the at least one processor, cause the apparatus to:
detect an input of the user prior to receiving the indication that the user device is preparing to enter a sleep state;
store the time period of inactivity in memory of the user device; and
use the stored time period of inactivity to update an expected content display time of another part of the content or a part of different content.

15. The apparatus of claim 11, wherein the at least part of the content comprises at least one image and/or text, wherein determining the expected content display time comprises estimating a complexity of the at least part of the content, and wherein the expected content display time is considered to be longer in response to a complexity considered to be high and is considered to be shorter in response to the complexity being considered low.

16. The apparatus of claim 15, wherein estimating the complexity of the at least part of the content is based on at least one of the following:
a resolution of the at least one image;
the number of the images;
a type of the image;
a number of words in the text;
a language complexity of text;
an average word size of the text; and
an average sentence size of the text.

17. The apparatus of claim 11, wherein the indication that the user device is preparing to enter the sleep state is an expiry of an inactivity timer.

18. The apparatus of claim 11, wherein:
for the case the expected content display time of the at least part of the content is greater than the time period of inactivity, the user device is caused to not enter the sleep state; and
for the case the expected content display time of the at least part of the content is less than the time period of inactivity, the user device is caused to enter the sleep state.

19. The apparatus of claim 11, wherein determining whether to cause the user device to enter the sleep state comprises:
determining a battery status is below a certain threshold, and causing the user device to enter the sleep state regardless of the comparison of the expected content display time of the at least part of the content and the time period of inactivity.

20. A computer program product comprising a computer readable storage medium having program instructions embodied therewith, the program instructions executable by a device to cause the device to:
determine an expected content display time for at least a part of content to be displayed to a user of a user device;
display the at least part of the content to the user;
monitor a time period of inactivity during which the user device does not detect an input from the user;
in response to receiving an indication that the user device is preparing to enter a sleep state, compare the time period of inactivity with the expected content display time of the at least part of the content; and
determine whether to cause the user device to enter the sleep state based at least on the comparison.
